(19) United States
(12) Patent Application Publication
(10) Pub. No.: US 2001/0008719 A1
(43) Pub. Date: Jul. 19, 2001

(54) Plate with regular projections, and device and method for forming the plate

(76) Inventor: Sadao Ikeda, Toyota-shi (JP)

Correspondence Address: KENYON & KENYON, One Broadway, New York, NY, 10004, US

(21) Appl. No.: 09/753,457

(22) Filed: Jan. 4, 2001

(30) Foreign Application Priority Data
Jan. 14, 2000 (JP) 2000-006913

(51) Int. Cl. H01M 8/00

(52) U.S. Cl. 429/12

(57) ABSTRACT

A plate formed with a plurality of regular projections projecting from both faces of the plate can suitably be used as a separator for a fuel cell. Projections on one face of the plate and projections on the opposite face of the plate are alternately and adjacently formed in at least one direction along a plane of a reference plate portion of a metal plate. The reference plate portion has not been deformed. The top face sections of the projections or bottom face sections of the projections are thicker than their peripheral corner portions.

### INCORPORATION BY REFERENCE

The disclosure of Japanese Patent Application No. 2000-006913 filed on Jan. 14, 2000 including the specification, drawings and abstract is incorporated herein by reference in its entirety.

### BACKGROUND OF THE INVENTION

1. Field of the Invention

The invention relates to a plate forward with a plurality of regular projections projecting outward from both faces of the plate, and a device and a method for forming the same.

2. Description of Related Art

For example, a polymer electrolyte fuel cell is constructed as follows. Electrodes are provided to sandwich a flat-plate-like electrolyte, thus constituting a unit cell. A multitude of unit cells are laminated to form a stack of fuel cells, and required voltage and current (i.e. electric power) is obtained therefrom. In this case, with a view to obtaining electric power through communication with the respective electrodes and supplying reaction gas such as fuel gas (e.g. hydrogen gas) or oxidizing gas (e.g. air) to the surface of the electrolyte through the respective electrodes, a separator is disposed on the front side of each of the electrodes (i.e. between the unit cells).

Accordingly, the separator is required to be made of a conductive material for the purpose of obtaining electric power, be in contact and communication with the electrode, and be provided with a flow passage for causing reaction gas to flow through a space between the separator and the surface of the electrode. To meet such requirements, it has been considered to form a plurality of projections in a conductive plate member made of a metal or the like, and use it as a separator. In this case, each projections are in contact with an electrode so that inside gas passages are formed between adjacent projections.

As a device for forming such a plate with regular projections, there is widely known a device having a pressing machine in which a pair of dies (pushing die and receiving die) is set. Also, there is known a device having a pair of rollers whose outer peripheral surfaces are formed with such a projection configuration. This device bends a blank by supplying it to a space between the rollers, and continuously make a plurality of projections in it. In addition, Japanese Patent Application Laid-Open No. HEI 10-216847 discloses a method for prolonging the period of endurance of a die. According to this method, a receiving die into which a pushing die proceeds is enlarged to the extent of avoiding contact with a blank. That is, this receiving die is designed as a so-called loose die. While the blank is extended by the pushing die, the blank is made to proceed into the receiving die. At this moment, since the blank does not slide along the inner surface of the receiving die, no abrasion is caused.

A so-called plate with regular projections obtained by the aforementioned devices is formed by a forming roll having a pushing die and a forming roll having a receiving die, and therefore is constructed to have projections protruding in only one of the thickness directions. In the case where such plates with regular projections are used as separators for a stack of fuel cells, upon abutment of the projections on electrodes, the separators come into contact with each other on their flat-face sides with no projections. As a result, it is impossible to ensure formation of a flow passage for causing coolant to flow therethrough to prevent a rise in temperature associated with generation of electricity. In order to ensure formation of a flow passage, a still another pair of plates with regular projections with their projections abutting on each other are required to be disposed between separators which are in contact with electrodes. This leads to an increase in the number of separators or plates with regular projections, an increase in size of the stack of fuel cells, and an increase in weight.

The aforementioned devices are constructed such that the pushing die is loosely fitted into the receiving die, for the purpose of reducing forming load and prolonging the period of endurance of the dies. Therefore, the load for holding the blank is insufficient. Also, the projections do not exactly follow the configuration of the pushing die or the receiving die, and the top faces of the projections are curved. Accordingly, if a product thus formed is used as a separator for a fuel cell, the internal resistance of the fuel cell may increase due to insufficient contact between projections and electrodes.

### SUMMARY OF THE INVENTION

The invention has been made in view of the aforementioned circumstances. It is an object of the invention to provide a plate which is easy to process with regular projections projecting from both faces of the plate, wherein the plate projections are alternately and continuously arranged and have bottom face sections or top face sections which are fairly flat. A further object is to provide a device and a method for manufacturing the same.

In a first aspect of the invention, there is provided a plate with regular projections comprising a plurality of first projections formed in a first thickness direction of a reference plate portion and a plurality of second projections formed in the opposite thickness direction of the reference plate portion and formed to be alternate with and adjacent to the projections in at least one direction in a plane of the reference plate portion.

According to the aforementioned aspect, if two plates with regular projections are arranged with the first projections abutting on each other or the top sections of the first projections and the top sections of the second projections abutting on each other, the inner surfaces of the projections face of one plate, the inner surfaces of the projections of the second plate, with wide space portions formed therebetween, and the space portions communicate with one another to form a flow passage with a large cross-section. At the same time, the projections are generated on those faces of the plates with regular projections which do not face each other. If flat-plate-like bodies such as electrodes of a fuel cell are made to abut on those faces, there is formed a continuous space between those faces and the flat-plate-like bodies. Thus, this continuous space can be used as a flow passage for fluid. That is, space portions serving as flow passages can be formed on both front and back sides of two plates with regular projections, and these plates can be used, for example, as separators for a stack of fuel cells.

At least either top face sections of the first or the second projections may be thicker than their peripheral corner portions.

Thereby the peripheral corner portions can be compressed, and an excess thickness generated thereby can be absorbed into the top face sections or the bottom face sections. As a result, it becomes possible to contour the corners of the projections or the projections and flatten the top face sections or the bottom face sections.

In another aspect of the invention, there is provided a forming device for a plate with regular projections, comprising a first forming roller having a first roller shaft to which a first separate-type die is mounted, a second forming roller having a second roller shaft to which a second separate-type die, which is a pair of the first separate-type die, is mounted, a controller that rotates the first and second forming rollers and continuously feeding a blank to a space between the forming rollers, and a mounting seat having a flat face and formed on at least one of outer peripheral surfaces of the first and second roller shafts. The first separate-type die has an outer peripheral surface at least partially formed with a projection forming configuration. The second separate-type die has an outer peripheral surface at least partially formed with a projection forming configuration paired with the projection configuration. At least one of the first and second separate-type dies is fixed to the mounting seat.

According to the aforementioned aspect, since the mounting seats for the separate-type dies for tonguing and grooving the blank are flat, the precision in positioning the separate-type dies can easily be enhanced. As a result, it becomes possible to reduce a so-called set-up time, enhance the rigidity for mounting the separate-type dies, and obtain products with high dimensional precision.

In the forming device according to the aforementioned aspect, a reference key for positioning the separate-type dies through abutment on one rotational edge portion of the mounting seat may further be provided.

In the forming device according to the aforementioned aspect, a delivery portion for applying a propelling force to the blank by sandwiching the blank on axially opposed sides across the projection configurations of the first and second forming rollers and rotating the blank may be provided. This makes it possible to prevent slippage between the blank and the forming rollers.

In another aspect of the invention, there is provided a method for forming a plate with regular projections comprising the steps of rotating a pair of forming rollers and passing a plurality of blanks through a space between the forming rollers and continuously forming a plurality of projections at least part of the blanks.

According to the aforementioned aspect, a plurality of plates with regular projections can be obtained at the same time. Therefore, it becomes possible to enhance the production efficiency of plates with regular projections.

In still another aspect of the invention, there is provided a method for forming a plate with regular projections, comprising the steps of passing a band-shaped continuous forming material through a pair of forming rollers and at least either machining or shearing a front portion of the forming material that has been formed in projection with a rear portion of the forming material being sandwiched between the forming rollers.

According to the aforementioned aspect, the tonguing and grooving processings and the machining or shearing of the projected portions are performed with the portions to be processed remaining united with the forming material. Thus, it is possible to perform machining or shearing without performing operations such as repositioning or identifying the forming material. Consequently, plates with regular projections can be manufactured with high precision and high efficiency.

### BRIEF DESCRIPTION OF THE DRAWINGS

Various exemplary embodiments of the invention will be described with reference to the accompanying drawings, in which like numerals are used to represent like elements and wherein:

FIG. 1 is a partial plan view of a plate with regular projections as one example of the invention.

FIG. 2A is a cross-sectional view taken along a line 2A-2A shown in FIG. 1.

FIG. 2B is a cross-sectional view taken along a line 2B-2B shown in FIG. 1.

FIG. 2C is a cross-sectional view taken along a line 2C-2C shown in FIG. 1.

FIG. 3 is a partially enlarged cross-sectional view of projected portions of the plate with regular projections.

FIG. 4 is a schematic cross-sectional view of the plate with regular projections used as a separator for a fuel cell.

FIG. 5 is a schematic view of the overall structure of a forming device according to the invention.

FIG. 6 is a cross-sectional view along the direction of axes of upper and lower forming rollers of the forming device shown in FIG. 5.

FIG. 7 is a cross-sectional view along the direction perpendicular to the axes of the upper and lower forming rollers of the forming device shown in FIG. 5.

FIG. 8 is a partial view of configurations of salient and recess portions of separate-type dies, the salient and recess portions corresponding to each other.

FIG. 9 is a layout diagram of the entire production unit including a forming device according to the invention.

FIG. 10 is a partial view of a state where a projections-forming processing is performed by the upper and lower forming rollers.

### DETAILED DESCRIPTION OF PREFERRED EMBODIMENT

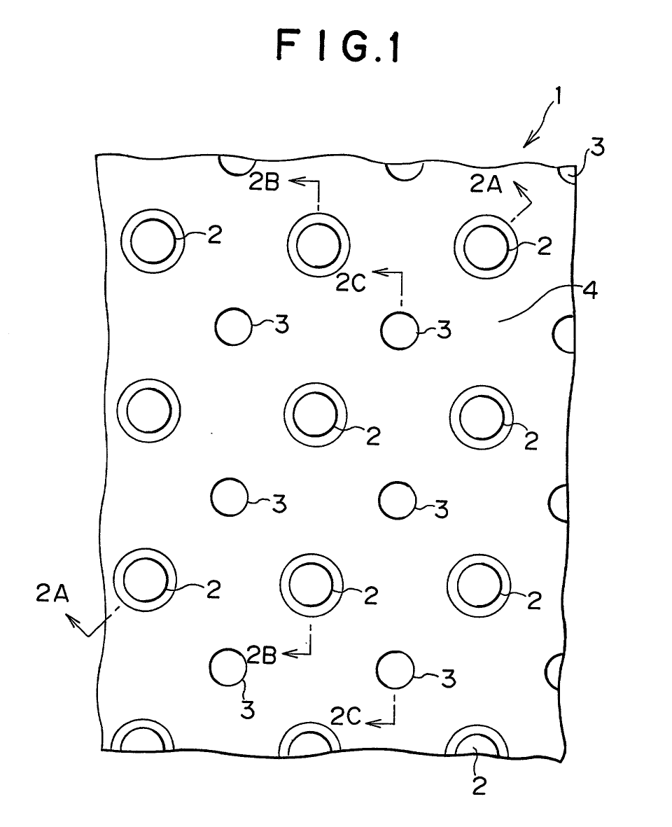

An embodiment of the invention will be described with reference to the drawings. First of all, a plate with regular projections of the invention will be described. FIG. 1 is a partial plan view of a plate 1 in which regular projections are formed, which is a conductive metal plate such as a stainless plate or an aluminum plate (which is, for example, approximately 0.1 to 0.3 mm in thickness). Projections 2 and projections 3 are alternately and continuously formed in the plate 1. The projections 2 are arranged in the form of a matrix at a constant pitch. The projections 3 formed on opposite side of the plate 1 are also arranged in the form of a matrix, but offset in up-and-down directions and left-and-right directions by half of the pitch. Thus, the projections 2 and the projections 3 are arranged as follows. That is, one projection 3 is located at the center of a square formed by connecting centers of four projections 2, and one projection 2 is located at the center of a square formed by connecting centers of four projections 3.

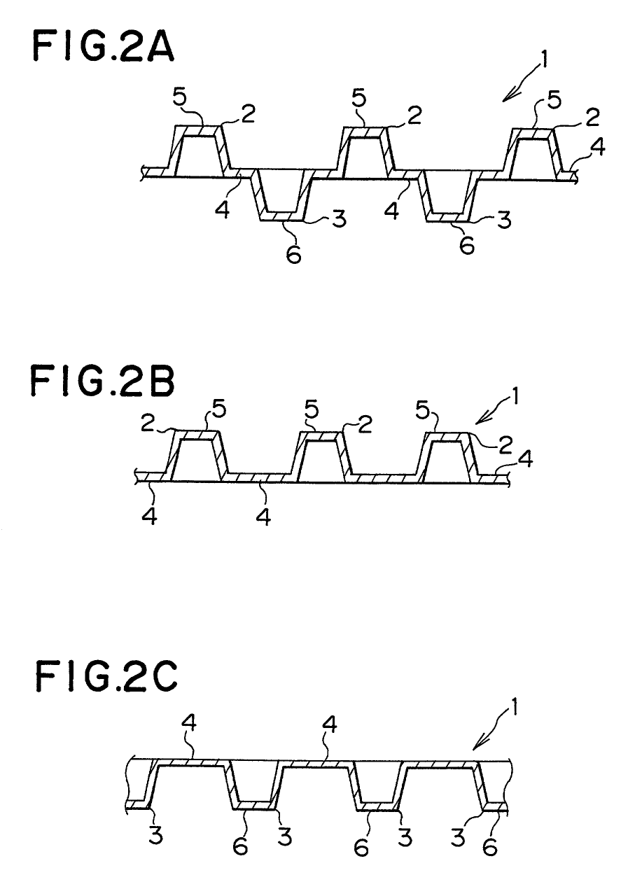

The projections 2 and the projections 3 assume a suitable cross-sectional shape such as a circular shape or an elliptical shape. In this embodiment, as shown in FIG. 1 and FIGS. 2A through 2C, the projections 2 and the projections 3 assume a circular cross-sectional shape with a diameter of approximately 1 mm and a trapezoidal longitudinal cross-sectional shape. The projections 2 and the projections 3 are formed by subjecting a blank to deformation such as coining. During deformation, the blank material moves or flows. There is a slight gap between two projections 2, between two projections 3, and between one projection 2 and one projection 3 respectively. The portion of the plate 1 other than the projections 2 and the projections 3 is a reference plate portion 4 which has not been deformed in the thickness direction.

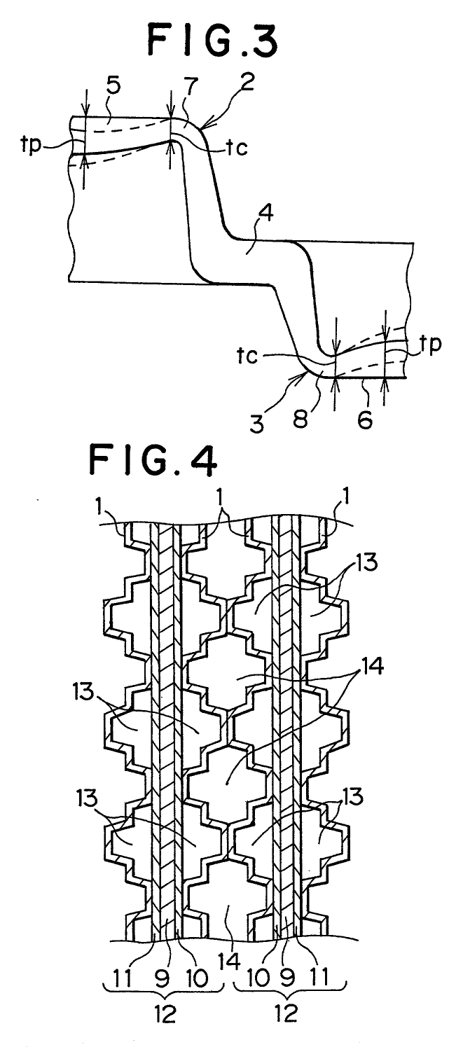

Furthermore, top sections 5 of the projections 2 and top sections 6 of the projections 3 are formed as flat faces parallel to the blank, that is, flat faces parallel to the reference plate portion 4. FIG. 3 is an enlarged view of a top sections 5, 6. As shown in FIG. 3, the top section 5 and the top section 6 have a thickness tp, and a peripheral corner portion 7 of the top section 5 and a peripheral corner portion 8 of the top section 6 have a thickness tc. To realize a flat shape as mentioned above, the thickness tc is set smaller than the thickness tp. This is a structure obtained by compressing the peripheral corner portions 7, 8 and thereby providing the top section 5 and the top section 6 with an excess thickness. That is, since the material is allowed to flow or move during compression, the load required for compression is reduced.

As indicated by broken lines in FIG. 3, the top sections 5, 6 are formed and processed so as to be slightly (by approximately several micrometers) curved towards the inner surface (i.e. towards the reference plate portion 4). By lifting the forming load, the top section 5, 6 undergo spring back, and are deformed towards the outer surface (i.e. in the direction opposite to the reference plate portion 4) to be flattened.

FIG. 4 schematically shows plate 1 in use as a separator for a fuel cell. A polymer electrolyte film 9 is sandwiched between an anode 10 and a cathode 11. The polymer electrolyte film 9, the anode 10 and the cathode 11 constitute a unit cell 12. Two plates with regular projections 1, which are in a mutually contacted or bonded state, are disposed between a pair of unit cells 12. The mutually contacted or bonded state refers to a state where outer surfaces of projections 2 abut on each other (front surfaces of two plates 1 face in opposite directions) or where outer surfaces of a projection 2 and a projection 3 abut on each other (front surfaces of two plates with regular projections 1 face in the same direction). In other words, this is a state where the projections 2 of one plate 1 are not fitted into the projections 3 of the other plate 1.

In this manner, the two plates 1 are sandwiched between the unit cells 12, so that the outer surfaces of the projections 2 or the projections 3 of the respective plates with regular projections 1 are in contact with electrodes 10, 11 of the unit cells 12 in such a manner as to allow supply of electricity. In other words, each of the unit cells 12 is sandwiched between the plates 1. In this state, while the plates with regular projections 1 have the projections 2, 3, the electrodes 10, 11 are flat. Therefore, gaps are created therebetween. These gaps communicate with one another. Thus, gas flow passages 13 for causing fuel gas (hydrogen gas) or oxidizing gas (air) to flow are formed on the sides of front surfaces of the electrodes 10, 11. The projections 2 and the projections 3 form space portions between a pair of plates 1. These space portions communicate with one another, thus forming flow passages 14. These flow passages 14 are separated from the gas flow passages 13 and designed, for example, to cause coolant to flow therethrough.

If hydrogen gas or air is caused to flow through gas flow passages 13 sandwiching a unit cell 12, an electrochemical oxidation reaction occurs across the polymer electrolyte film 9. Consequently, electric power is generated and outputted to the outside through the plates 1 serving as separators. In this case, the top sections 5 of the projections 2 and the top sections 6 of the projections 3 of the plates 1 are formed as flat surfaces like the electrodes 10, 11. Therefore, the plates 1 are in contact with the electrodes 10, 11 over a large contact area, and the electric conductivity therebetween becomes high. As a result, the entire fuel cell has a reduced internal resistance. That is, power generation efficiency of the fuel cell becomes high. Because an electromotive force of the fuel cell is obtained by an oxidation reaction of hydrogen gas, heat is generated simultaneously with power generation. However, since the plate 1 has the flow passages 14 formed in conjunction with the gas flow passages 13, it becomes possible to prevent an excessive rise in temperature by causing coolant to flow through the flow passages 14.

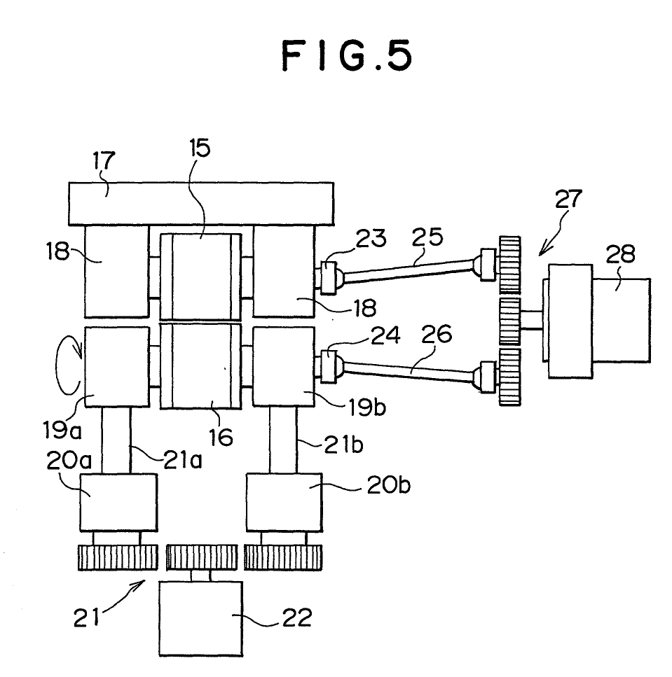

Next, a forming device for forming the plate 1 according to the invention will be described. FIG. 5 is a schematic view of the forming device. A pair of upper and lower forming rollers 15, 16 are arranged close to each other and parallel to each other. The upper forming roller 15 is rotatably held at both ends by a holder 18 integrated with a body 17 constituting a frame portion of the entire device. The lower forming roller 16 is rotatably held at left and right axial ends by vertically movable holders 19a, 19b. The vertically movable holders 19a, 19b are coupled to ball screw units 21a, 21b connected to output portions of decelerators 20a, 20b respectively. Input members of the decelerators 20a, 20b are connected to a motor 22 through a gear unit 21. By rotating the ball screw units 21a, 21b by means of the motor 22, the vertically movable holders 19a, 19b are vertically moved to adjust a gap between the upper and lower forming rollers 15, 16.

Drive shafts 25, 26 are coupled to the axial ends of the upper and lower forming rollers 15, 16 through universal joints 23, 24 respectively. The drive shafts 25, 26 are coupled to a decelerator-equipped motor 28 through a gear unit 27. Accordingly, the upper and lower forming rollers 15, 16 are rotated by the motor 28.

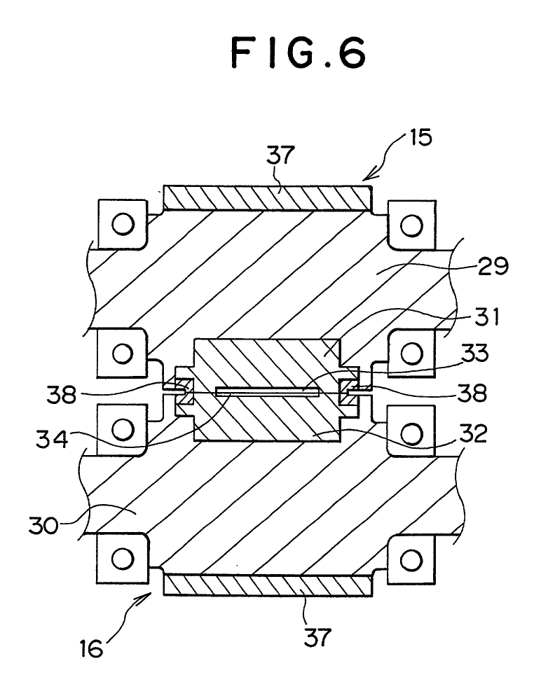

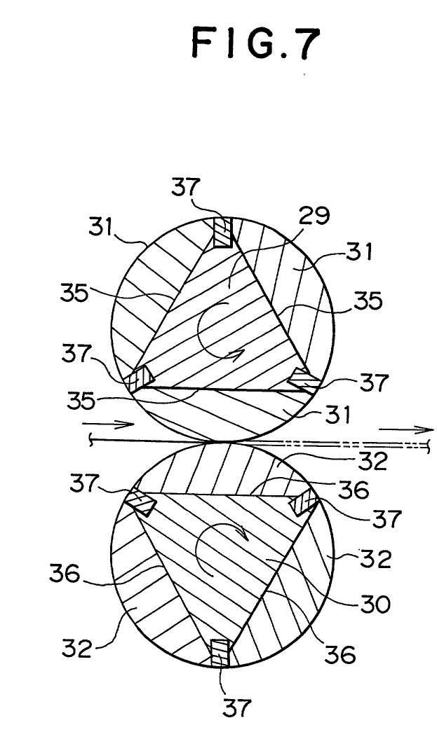

FIGS. 6, 7 show structures of the forming rollers 15, 16 respectively. The forming rollers 15, 16 are respectively constructed by fixing separate-type dies 31, 32 to outer peripheral portions of roller shafts 29, 30 coupled to the drive shafts 25, 26 respectively. The separate-type dies 31, 32 have arcuate outer peripheral surfaces each having a length of approximately one-third of the entire circumference. Projected portions 33, 34 corresponding to projection configurations of a product to be obtained are formed in laterally central portions of the outer peripheral surfaces. The dies 31, 32 have portions serving as chords for the arcs. These chords are formed as flat surfaces. Accordingly, the separate-type dies 31, 32 have a cross-sectional shape of a short thin pike.

On the other hand, axially central portions of the roller shafts 29, 30 generally have a cross-sectional shape of an equilateral triangle. The roller shafts 29, 30 have flat portions corresponding to sides of the triangle. These portions serve as mounting seats 35, 36 of the separate-type dies 31, 32 respectively (see FIG. 7).

The roller shafts 29, 30 have boundary portions for the mounting seats 35, 36, that is, portions corresponding to apexes of the aforementioned triangles. Reference keys 37 are mounted to these portions. The reference keys 37 are block-like or rectangular-shaft-like members which have, for example, a rectangular cross-sectional shape and are longer than the width of the mounting seats 35, 36. The reference keys 37 are processed with high dimensional precision so that their lateral faces serve as reference planes for determining positions for mounting the separate-type dies 31, 32.

Furthermore, delivery rings 38 constituting delivery portions are provided in axially opposed sections of the projected portions 33, 34 of the separate-type dies 31, 32. The delivery rings 38 are band-shaped arcuate members. Rough surface portions are formed on the outer peripheral surfaces of the delivery rings 38 by means of knurling or the like. The blank is sandwiched between the upper and lower delivery rings 38 and rotated. Thereby a delivery force (a propelling force) is applied to the blank.

A structure and a procedure for mounting the forming rollers 15, 16 will briefly be described. First of all, the reference keys 37 are mounted to the roller shafts 29, 30. This is carried out by tightening bolts (not shown) penetrating the reference keys 37 in the outside-to-inside direction with respect to radii of the roller shafts 29, 30. The separate-type dies 31, 32 are set between the respective reference keys 37, that is, on the mounting seats 35, 36 respectively. In this case, tapered pins protruding towards the separate-type dies 31, 32 or members having tapered apex portions are disposed on the one-axial-end side of the mounting seats 35, 36. Notched portions (not shown) fitted to the tapered portions are formed in axial end face portions of the separate-type dies 31, 32. With the tapered portions saddle-fitted to the notched portions, the separate-type dies 31, 32 are pressed against the tapered members so that a load is applied to the separate-type dies 31, 32 in the circumferential direction. Thereby the separate-type dies 31, 32 come into close contact with the reference keys 37 and are then positioned. In this state, the delivery rings 38 are set at the axial ends of the separate-type dies 31, 32. Using the bolts screwed in the outside-to-inside direction with respect to the radii of the roller shafts 29, 30, the separate-type dies 31, 32 equipped with the delivery rings 38 are fixed to the roller shafts 29, 30.

Phase adjustment of the upper and lower forming rollers 15, 16 is carried out by means of the reference keys 37. That is, slits for phase adjustment are formed in the reference keys 37 for the upper and lower forming rollers 15, 16, and keys or pins (not shown) are inserted into the slits to determine phases of the upper and lower forming rollers 15, 16. Thereby phase adjustment of the upper and lower dies 31, 32 is carried out.

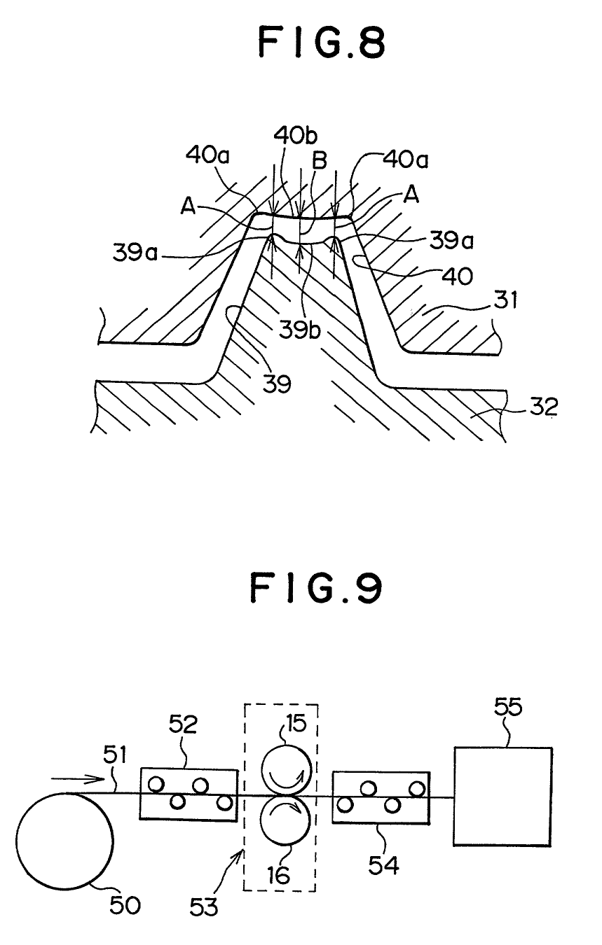

The separate-type dies 31, 32 are designed to form the projected configurations shown in FIGS. 1 through 3. Accordingly, a salient portion 39 of one die and a recess portion 40 of the other die corresponding thereto are constructed to have partially different gaps therebetween. FIG. 8 shows a concrete example. As shown in FIG. 8, there is a gap A created between an edge section 39a of the salient portion 39 and a corner section 40a of the recess portion 40, and there is a gap B created between a top face section 39b of the salient portion 39 and a bottom face section 40b of the recess portion 40. The gap A is set smaller than the gap B. The gap A is set to a value smaller than the thickness of the blank. The blank is compressed in the gap A.

Furthermore, the top face section 39b of the salient portion 39 is curved and recedes in such a direction as to move away from the bottom face section 40b of the recess portion 40. On the other hand, the bottom face section 40b of the recess portion 40 is curved and protrudes towards the top face section 39b. By making an amount of protrusion of the bottom face section 40b smaller than an amount of recession of the top face section 39b, the aforementioned gaps A, B are made different from each other.

The aforementioned forming device is capable of processing a blank reeled out of a stainless steel plate coil or a coil of aluminum or its alloy. FIG. 9 shows a layout example of the forming device. A forming material 51 is reeled out to a leveler 52 from a coil 50, which has been reeled off from a band-shaped forming material. The leveler 52 straightens the forming material 51. A forming device 53 equipped with the forming rollers 15, 16 is disposed downstream of the leveler 52. A leveler 54 for correcting the overall deformed portion resulting from the tonguing-and-grooving processing to a flat shape is disposed downstream of (on the outlet side of) the forming device 53. A cutting device 55 such as a pressing machine is disposed downstream of the leveler 54.

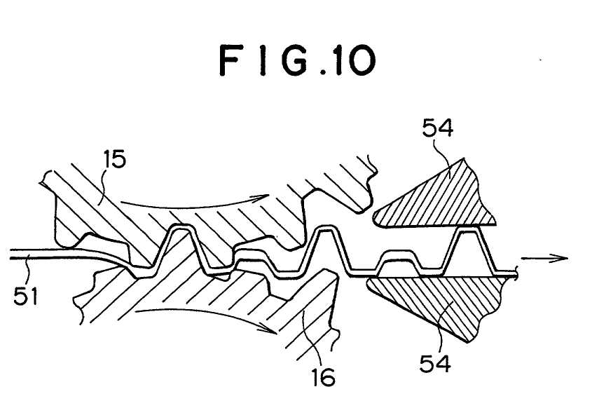

Next, a method for forming a plate with regular projections by means of the forming device 53 will be described. The forming material 51 reeled out of the coil 50 passes through the leveler 52 and is thereby straightened into a straight flat plate. The forming material 51 in this state is supplied to the forming device 53 and sandwiched between the upper and lower forming rollers 15, 16. The forming rollers 15, 16 are rotated by the motor 28 in opposite directions. Accordingly, the forming material 51 which has been supplied to a space between the forming rollers 15, 16 is formed in projections by the salient portion 39 of one separate-type die and the recess portion 40 of the other separate-type die. FIG. 10 schematically shows this state.

In this case, a load resulting from the projections-forming processing is applied to the separate-type dies 31, 32. However, the separate-type dies 31, 32 are mounted to the flat mounting seats 35, 36 and positioned through abutment on the reference keys 37 disposed on the rotational end sides. Thus, the separate-type dies 31, 32 are rigidly mounted, and therefore prevented from being dislocated due to a forming processing. Because the separate-type dies 31, 32 are positioned as described above, a pair of upper and lower separate-type dies 31, 32 can be positioned with high precision and prevented from being dislocated with respect to each other. Therefore, while it is possible to perform the forming processing with high precision, it is possible to prevent mutual interference of the separate-type dies 31, 32, an increase in forming load, breakage of the dies and the like.

The forming material 51 is sandwiched between the upper and lower separate-type dies 31, 32 while being sandwiched between the delivery rings 38. The delivery rings 38 apply a propelling force to the forming material 51 and move it forwards. As a result, the forming material 51 is prevented from being dislocated with respect to the forming rollers 15, 16. Thus, processing precision is improved.

Although only one sheet of the forming material 51 may be supplied to the forming device 53, a plurality of laminated sheets of the forming material 51 of the same type, different types or different compositions may also be supplied to the forming device 53. In this case, the gap between the upper and lower forming rollers 15, 16 is adjusted in accordance with the thickness of the entire forming material 51. This makes it possible to form a plurality of plates with regular projections in one step.

The forming material 51 sandwiched between the upper and lower separate-type dies 31, 32 is sequentially and continuously deformed in accordance with the configurations of the salient portion 39 and the recess portion 40 of the separate-type dies 31, 32. In this case, while the forming material 51 is deformed with extension (flow) of the material, the portion corresponding to the edge section 39a of the salient portion 39 is compressed. This processing is designed to contour the projection shape of the product. In this case, the material moves because of compression. Because the gap between the top face section 39b of the salient portion 39 and the bottom face section 40b of the recess portion 40 has been widened, the material moves towards the gap. That is, since compression is carried out while allowing flow of the material, the load required for compression can be reduced. Even though the forming material 51 is inevitably inhomogeneous in thickness, it is possible to absorb an excess thickness if the forming material 51 is thick. Therefore, it is possible to prevent the forming load from becoming excessively large.

Furthermore, in portions to be formed in projections by the salient portion 39 and the recess portion 40, the forming material 51 is processed (e.g. coined) in such a manner as to allow extension or flow of the material. However, the top face section 39b of the salient portion 39 and the bottom face section 40b of the recess portion 40 are curved as described above, and the forming material 51 is deformed to be curved in the direction opposite to the direction for processing the projections 2 and the projections 3. Therefore, even if the processed portion that has been drawn out of the space between the upper and lower forming rollers 15, 16 has undergone spring back, the top face sections 5 of the projections 2 and the bottom face sections 6 of the projections 3 remain flat.

The processed portion that has been formed in projections as described above is fed to the leveler 54 disposed downstream of the forming device 53. The projected portion that has been processed is held and corrected to a flat shape as a whole, and then supplied to the cutting device 55. The cutting device 55 perforates the processed portion as required, or performs shearing or machining such as trimming so as to punch out the processed portion from the forming material 51. This processing is carried out for the front portion of the forming material 51 with the rear portion thereof being sandwiched between the forming rollers 15, 16 of the forming device 53. Therefore, it is possible to easily detect or determine portions to be processed by the cutting device 55. Also, since both the processings can be synchronized with each other, the productivity and quality of the products can be improved.

What is claimed is:

1. A plate with regular projections comprising:
a plurality of first projections formed in a thickness direction of a reference plate portion of the plate; and
a plurality of second projections formed in the opposite thickness direction of the reference plate portion and formed to be alternate with and adjacent to the first projections in at least one direction in a plane of the reference plate portion.

2. The plate with regular projections according to claim 1, wherein:
at least one of top face section of the first and the second projections is thicker than its peripheral corner portions.

3. A forming device for forming a plate with regular projections, comprising:
a first forming roller having a first roller shaft to which a first separate-type die is mounted, the first separate-type die having an outer peripheral surface at least partially formed with a projected forming configuration;
a second forming roller having a second roller shaft to which a second separate-type die is mounted, the second separate-type die having an outer peripheral surface at least partially formed with a projection forming configuration paired with the projected forming configuration;
a controller that rotates the first and second forming rollers and continuously feeds a blank to a space between the forming rollers; and
a mounting seat having a flat face and formed on at least one of outer peripheral surfaces of the first and second roller shafts, wherein:
at least one of the first and second separate-type dies is fixed to the mounting seat.

4. The forming device according to claim 3, further comprising:
a reference key that positions at least one of the first and the second separate-type dies through abutment on one rotational edge portion of the mounting seat.

5. The forming device according to claim 3, further comprising:
a delivery portion for applying a propelling force to the blank by sandwiching the blank on axially opposed sides across the projection configurations of the first and second forming rollers and rotating the blank.

6. The forming device according to claim 4, further comprising:
a delivery portion for applying a propelling force to the blank by sandwiching the blank on axially opposed sides across the projection configurations of the first and second forming rollers and rotating the blank.

7. A method for forming a plate with regular projections, comprising:
rotating a pair of forming rollers; and
passing a plurality of blanks through a space between the forming rollers and continuously forming a plurality of the projections in at least part of the blanks.

8. A method for forming a plate with regular projections, comprising:
passing a band-shaped continuous forming material through a pair of forming rollers; and
at least either machining or shearing a front portion of the forming material in which the projections have been formed, with a rear portion of the forming material being sandwiched between the forming rollers.
